(19) United States
(12) Patent Application Publication
(10) Pub. No.: US 2022/0234359 A1
(43) Pub. Date: Jul. 28, 2022

(54) CONTROLLER AND METHOD FOR INTERRUPTING THE PRINTING OPERATION OF A PRINTING DEVICE

(71) Applicant: Canon Production Printing Holding B.V., Hh Venlo (NL)

(72) Inventor: Ulrich Stöckle, München (DE)

(73) Assignee: Canon Production Printing Holding B.V., Hh Venlo (NL)

(21) Appl. No.: 17/577,669

(22) Filed: Jan. 18, 2022

(30) Foreign Application Priority Data
Jan. 22, 2021 (DE) 10 2021 101 308.9

(51) Int. Cl. B41J 2/165; B41J 2/045

(52) U.S. Cl. CPC B41J 2/16535; B41J 2/04586; B41J 2/04551

(57) ABSTRACT

A controller may transition an inkjet printing device, starting from the printing operation, at least predominantly into a continuation mode where the printing is interrupted in which, however, the active tempering of the ink in the one or more print heads of the printing device is continued in order to enable an accelerated restart of the printing operation.

### CROSS REFERENCE TO RELATED APPLICATIONS

This patent application claims priority to German Patent Application No. 102021101308.9, filed Jan. 22, 2021, which is incorporated herein by reference in its entirety.

### BACKGROUND

### Field

The disclosure relates to a method and a controller for interrupting the printing operation of an inkjet printing device, in particular an inkjet printing device for printing to a recording medium in the form of a belt or web.

### Related Art

An inkjet printing device for printing to a recording medium has at least one print bar with one or more print heads, wherein each print head typically has a plurality of nozzles. The nozzles are respectively configured to eject ink droplets in order to print dots of a print image on the recording medium.

It may be necessary to interrupt the printing operation of an inkjet printing device, for example in order to check the print quality of the printing device. Upon stopping the printing device and/or upon resuming the printing operation of the printing device, one or more conditioning measures are typically implemented to condition and/or regenerate the printing device, which measures are linked with a relatively high cost in terms of time and/or material, in particular for ink.

### BRIEF DESCRIPTION OF THE DRAWINGS/FIGURES

The accompanying drawings, which are incorporated herein and form a part of the specification, illustrate the embodiments of the present disclosure and, together with the description, further serve to explain the principles of the embodiments and to enable a person skilled in the pertinent art to make and use the embodiments.

FIG. 1a a block diagram of an inkjet printing device according to an exemplary embodiment.

FIG. 1b a bottom view a regenerator of an inkjet printing device according to an exemplary embodiment.

FIG. 1c a side view of a regenerator of an inkjet printing device according to an exemplary embodiment.

FIG. 2 flowchart of a method for interrupting the printing operation of a printing device according to an exemplary embodiment.

The exemplary embodiments of the present disclosure will be described with reference to the accompanying drawings. Elements, features and components that are identical, functionally identical and have the same effect are—insofar as is not stated otherwise—respectively provided with the same reference character.

### DETAILED DESCRIPTION

In the following description, numerous specific details are set forth in order to provide a thorough understanding of the embodiments of the present disclosure. However, it will be apparent to those skilled in the art that the embodiments, including structures, systems, and methods, may be practiced without these specific details. The description and representation herein are the common means used by those experienced or skilled in the art to most effectively convey the substance of their work to others skilled in the art. In other instances, well-known methods, procedures, components, and circuitry have not been described in detail to avoid unnecessarily obscuring embodiments of the disclosure. The connections shown in the figures between functional units or other elements can also be implemented as indirect connections, wherein a connection can be wireless or wired. Functional units can be implemented as hardware, software or a combination of hardware and software.

An object of the present disclosure is to reduce the cost, in particular the time and/or material cost, upon interrupting the printing operation of a printing device.

According to one aspect of the disclosure, a controller for interrupting the printing operation of an inkjet printing device is described that has at least one print head with at least one nozzle for printing to a recording medium. In reaction to a detected stop request to stop the printing operation of the printing device, the controller is configured to transition the printing device from the printing operation into a continuation mode, wherein in the continuation mode the printing of the recording medium is interrupted but an active tempering of ink in the print head continues to take place. The controller is also configured to resume the printing operation of the printing device in reaction to a subsequent restart request to restart the printing operation of the printing device.

According to a further aspect, a method is described for interrupting the printing operation of an inkjet printing device that has at least one print head with at least one nozzle. The method includes the transition of the printing device from the printing operation into a continuation mode in reaction to a detected stop request to stop the printing operation of the printing device. In the continuation mode, the printing of a recording medium, in particular of a recording medium in the form of a belt or web, is interrupted, but an active tempering of ink continues to take place in the print head, in particular corresponding to the target temperature of the ink during the printing operation. The method also includes the resumption of the printing operation of the printing device in reaction to a subsequent restart request to restart the printing operation of the printing device. The restart can thereby efficiently take place directly from the continuation mode.

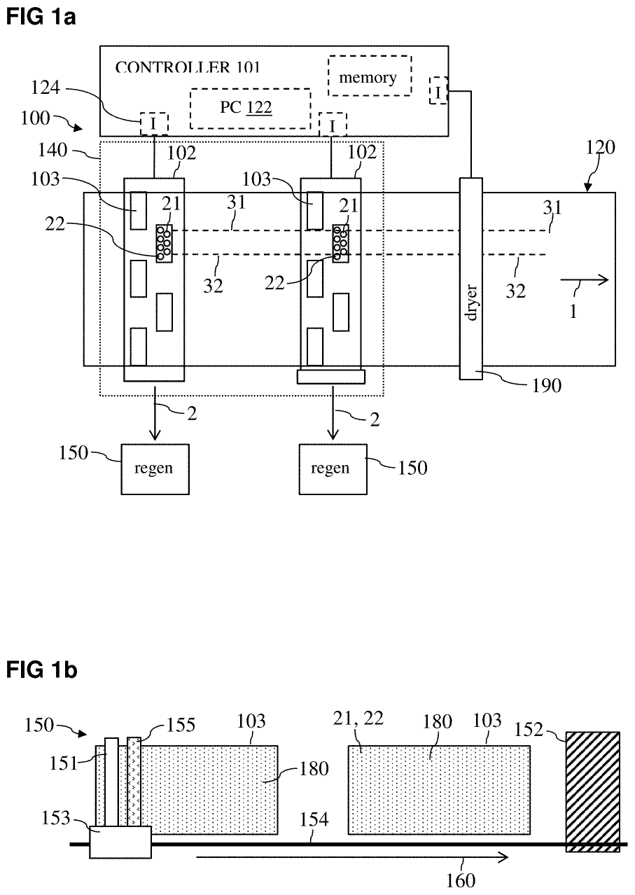

The printing device 100 depicted in FIG. 1a is designed for printing to a recording medium 120 in the form of a belt or web. The printing device 100 may be designed to take the recording medium 120 in the form of a web off of a roll. The recording medium 120 may be manufactured from paper, paperboard, cardboard, metal, plastic, textiles, a combination thereof, and/or other materials that are suitable and can be printed to. The recording medium 120 is transported along the transport direction 1 (represented by an arrow) through the print group 140 of the printing device 100.

In the depicted example, the print group 140 of the printing device 100 comprises two print bars 102, wherein each print bar 102 may be used for printing with ink of a defined color (for example black, cyan, magenta, and/or yellow, and if applicable MICR ink). Furthermore, the printing device 100 typically comprises at least one fixer or dryer 190 that is configured to fix a print image printed onto the recording medium 120.

A print bar 102 may comprise one or more print heads 103 that are possibly arranged side by side in a plurality of rows in order to print the dots of different columns 31, 32 of a print image onto the recording medium 120. In the example depicted in FIG. 1a, a print bar 102 comprises five print heads 103, wherein each print head 103 prints the dots of a group of columns 31, 32 of a print image onto the recording medium 120.

In the embodiment depicted in FIG. 1a, each print head 103 of the print group 140 comprises a plurality of nozzles 21, 22, wherein each nozzle 21, 22 is configured to fire or eject ink droplets onto the recording medium 120. A print head 103 of the print group 140 may, for example, comprise multiple thousands of effectively utilized nozzles 21, 22 that are arranged along a plurality of rows transverse to the transport direction 1 of the recording medium 120. By means of the nozzles 21, 22 of a print head 103 of the print group 140, dots of a line of a print image may be printed onto the recording medium 120 transverse to the transport direction 1, meaning along the width of the recording medium 120.

The printing device 100 also comprises a controller 101, for example an activation hardware and/or a processor that is configured to activate the actuators of the individual nozzles 21, 22 of the individual print heads 103 of the print group 140 in order to apply the print image onto the recording medium 120 depending on print data. In an exemplary embodiment, the controller 101 includes processing circuitry 122 that is configured to perform one or more functions and/or operations of the controller 101, including activating the actuators of the individual nozzles 21, 22 of the individual print heads 103 of the print group 140 to apply the print image onto the recording medium 120 based on print data, processing print and/or other data, controller one or more modes of the printer device 100 and/or controlling one or more operations of the printing device 100. In an exemplary embodiment, the controller 101 includes one or more interfaces 124 (e.g. a wired and/or wireless input and/or output interface, transceiver, or the like) that is configured to receive or output data or information. For example, the controller 101 may receive signals generated by one or more components of the printing device 100 (e.g. from a user interface of the printer device 100) and/or output control signals to one or more components of the printing device 100. In an exemplary embodiment, the controller 101 includes a memory configured to store data/information, and/or store executable code that is executable by the processing circuitry 122 to cause the processing circuitry to perform the operation(s) of the controller 101.

The print group 140 of the printing device 100 thus comprises at least one print bar 102 with K nozzles 21, 22 that may be activated with a defined line timing in order to print a line with K pixels or K columns 31, 32—for example with K>1000—of a print image onto the recording medium 120, said line traveling transverse to the transport direction 1 of the recording medium 120. In the depicted example, the nozzles 21, 22 are installed immobile or fixed in the printing device 100, and the recording medium 120 is directed past the stationary nozzles 21, 22 with a defined transport velocity.

Furthermore, the printing device 100 comprises one or more regenerators 150 for the corresponding one or more print bars 102. A print bar 102 may be transitioned from a printing position, at which the print bar 102 is arranged above the recording medium 120, into a cleaning or maintenance position. For this purpose, the print bar 102 may be moved in the movement direction 2 (indicated by an arrow). The nozzle plates of the one or more print heads 103 of a print bar 102 may then be cleaned, for example wiped off, using a regenerator 150. The printing device 100 may have at least or precisely one regenerator 150 for each print bar 102.

FIG. 1b shows a view of the regenerator 150, from below, on the nozzle plates 180 of two print heads 103 of a print bar 102, and FIG. 1c shows a view of the regenerator 150 from the side, with a print bar 102 that has three print heads 103. The print heads 103 are arranged one after another along a cleaning axis 160. The cleaning axis 160 thereby typically travels transverse to the transport direction 2. The outputs or nozzle openings of the one or more nozzles 21, 22 of the print head 103 are arranged on the underside or on the nozzle opening 180 of a print head 103.

In the cleaning or maintenance position, the one or more nozzles 21, 22 of the print head 103 may be induced to eject ink, for example by increasing the pressure within the one or more nozzles 21, 22. This step is typically referred to as “purging”. Furthermore, the nozzle plate 180 of a print head 103 may be sprayed with a (cleaning) fluid 156 by one or more spray nozzles 155. The underside or nozzle plate 180 of a print head 103 may subsequently be cleaned with a wiper 151. The wiper 151 may be moved along the cleaning axis 160 across the nozzle plate 180 of a print head 103 in order to clean the nozzle plate 180 of ink that remains on the nozzle plate 180. This step is typically referred to as “wiping”.

The wiper 151 and/or the spray nozzle 155 may be attached, separately or jointly, to a sled or a wiper mount 153 that is directed along a guide rail 154 on a nozzle plate 180 of a print head 103. A sled 13 may thereby guide one or more wipers 11 across the nozzle plates 180 of a plurality of—in particular all—print heads 103 of a print bar 102. The fluid that is thereby wiped off may drip into a trough (not shown), wherein the trough is arranged below the sled 153. After the nozzle plates 180 of the one or more print heads 103 have been wiped off, the wiper 11 may be moved into a cleaner 152 in which the wiper 151 is cleaned.

It may occur that the printing operation of the printing device (printer) 100 is interrupted, for example during the printing of a print job, for example because the user of the printing device 100 would like to check the print job. In order to guarantee a uniformly high print quality, following the interruption of the printing operation, a print head cleaning is typically implemented within the regenerator 150 before each printing start. The print head cleaning typically also takes place when the printing operation is interrupted only for a relatively short time period, for instance because an error has occurred or because a print setting was incorrect.

Given a restart of the printing operation, the printing device 100 thus typically runs through the a complete preparation program, independently of whether the printing device 100 has been interrupted for a relatively long time period (for example multiple hours) or only for a relatively short time period (for example a few minutes). Within the scope of the preparation for the printing operation, in addition to the regeneration of the one or more print heads 103, the ink in the one or more print heads 103 and/or the dryer 190 of the printing device 100 may be tempered in order to have the effect that the ink and/or the dryer 190 exhibit a predefined target temperature for the printing operation upon the start of printing. The tempering and the regeneration are linked with a relatively high time cost, for example 3 minutes or more, and/or with a relatively high material cost, in particular for ink.

The controller 101 of the printing device 100 may be designed to transition the printing device 100 into a continuation mode as a result of a request for a print stop, in particular when it is expected that the printing operation of the printing device 100 will be stopped for only a relatively short time period. The continuation mode may thereby be designed such that the printing device 100, starting from the continuation mode, can be transitioned relatively quickly into the printing operation again without negatively affecting the print quality.

The operation of the printing device 100 in the continuation mode may be limited to a defined maximum duration. After exceeding the maximum duration, or after exceeding a time threshold corresponding to the maximum duration, it may possibly be automatically effected that the printing device 100 is transitioned into the stop state or stop mode. Upon restarting the printing operation of the printing device 100, starting from the stop mode, the complete preparation program is then implemented in order to ensure a high print quality even after a relatively long print interruption.

In continuation mode, the printing device 100 may be designed to continue the tempering of the ink and/or of the dryer 190 with respect to the respective target temperature. As a result of thus, upon restarting the printing operation, a resetting of the respective target temperature does not need to be implemented, such that the duration of the restart can be reduced.

Within the scope of the continuation mode, the printing device 100 may also be configured to implement a basic cleaning of the one or more print heads 103 following the interruption of the printing operation and independently of a request for a restart of the printing operation. The basic cleaning may, for example, be implemented directly following the interruption of the printing operation or directly at the beginning of the continuation mode. In the basic cleaning of a print head 103, the nozzle plate 180 may be sprayed with cleaning fluid 156. The cleaning fluid 156 may also be wiped off with a wiper 151. In the basic cleaning, a flushing of the individual nozzles 21, 22 of the print head 103 with ink may be foregone. The duration of the cleaning and the material consumption, in particular with respect to ink, may thus be reduced.

Moreover, within the scope of the continuation mode, the one or more print bars 102 of the printing device 100 may be transitioned from a printing position above the recording medium 120 into a park position. A print bar 102 in the park position may thereby possibly likewise be arranged above the recording medium 120. For this purpose, the one or more print heads 103 of the print bar 102 may be raised so that the clearance between the nozzle plates 180 of the one or more print heads 103 of the print bar 102 and the recording medium 120 is increased. A covering for the nozzle plates 180 of the one or more print heads 103 may then be placed below the one or more print heads 103, via which a drying out of the nozzles 21, 22 is prevented or at least delayed. The nozzle plates 180 of the one or more print heads 103 may possibly be immersed into a fluid bath in order to further delay the drying out of the nozzles 21, 22.

The controller 101 of the printing device 100 may be configured to detect a request for a restart of the printing operation while the printing device 100 is in continuation mode. The one or more print bars 102 may then be transitioned from the park position into the printing position, and the printing operation may be directly resumed. A (temporary) interruption of the printing operation may thus be efficiently enabled, in particular without significant wait times for the user of the printing device 100.

A “Fast Print Resume” mode, meaning a continuation mode, may thus be provided for a printing device 100 that enables the user of said printing device 100 to rapidly restart the printing operation of the printing device 100 after an interruption of the printing operation. In continuation mode, the ink and/or the dryer 190 may continue to be tempered so that the ink and/or the dryer 190 do not need to be reheated before restarting the printing operation. The productivity of the printing device 100 may thus be increased, since the time for heating may be saved.

The continuation mode may also be designed such that the one or more print heads 103 of the printing device 100 are not cleaned before the restart of the printing operation, but rather directly after the end of the previous, interrupted print run. Within the scope of the cleaning, upon stopping the printing operation only the nozzle plates 180 of the one or more print heads 103 can, if applicable, be sprayed and withdrawn so that this cleaning takes less time than a cleaning including purging of the nozzles 21, 22 of the one or more print heads 103. Via the spraying and the stripping of the nozzle plates 180 of the one or more print heads 103, it may be effected that no ink dries on the individual nozzle plates 180 and thereby negatively affects the subsequent printing operation.

Furthermore, within the scope of the continuation mode, a negative ink pressure may be applied at the one or more print heads 103, which negative ink pressure is greater than the negative ink pressure during the printing operation, for example greater by 10 mbar or more. It may thus be effected that the ink is drawn further back into the nozzles 21, 22 or the one or more print heads 103 during the continuation mode than during the printing operation. A drying of the ink in the nozzles 21, 22 of the one or more print heads 103 may thus be reliably avoided, or at least slowed.

The one or more print heads 103 may be brought into the respective park position during the continuation mode, in particular following the spraying and stripping. A print head 103 in the park position may thereby be arranged in a park hatch, and/or the nozzle plate 180 of the print head 103 may be covered with a park hatch. The one or more print heads 103 may also be placed directly above the recording medium 120 to be printed to. The one or more print bars 102 may thereby already be arranged in the printing position. On the other hand, the one or more print heads 103 of the individual print bar 102 may respectively be arranged in a park position covered with park hatches. It may thus be achieved that the one or more print heads 103 are again ready to be used for the printing operation in a brief amount of time, for example within a few seconds.

At the beginning of the restarted printing operation, following the stop mode and/or following the continuation mode, a regeneration print image may initially be printed, in particular with one or more refresh pages. By printing a regeneration print image, it may be effected that the ink in the nozzles 21, 22 of the printing device 100 is refreshed. For example, the regeneration print image may be designed such that the entire fill quantity of every single print head 103 is used at least once or at least twice to print the regeneration print image.

Alternatively or additionally, for example following the printing of a regeneration print image, a test print image may be printed that enables one or more negatively affected, in particular failed nozzles 21, 22 of the printing device 100 to be detected. A check may thus be made as to whether the print quality of the printing device 100 is sufficient or is possibly negatively affected. If applicable, one or more measures for the compensation of a failed nozzle 21, 22 may be taken during the printing operation.

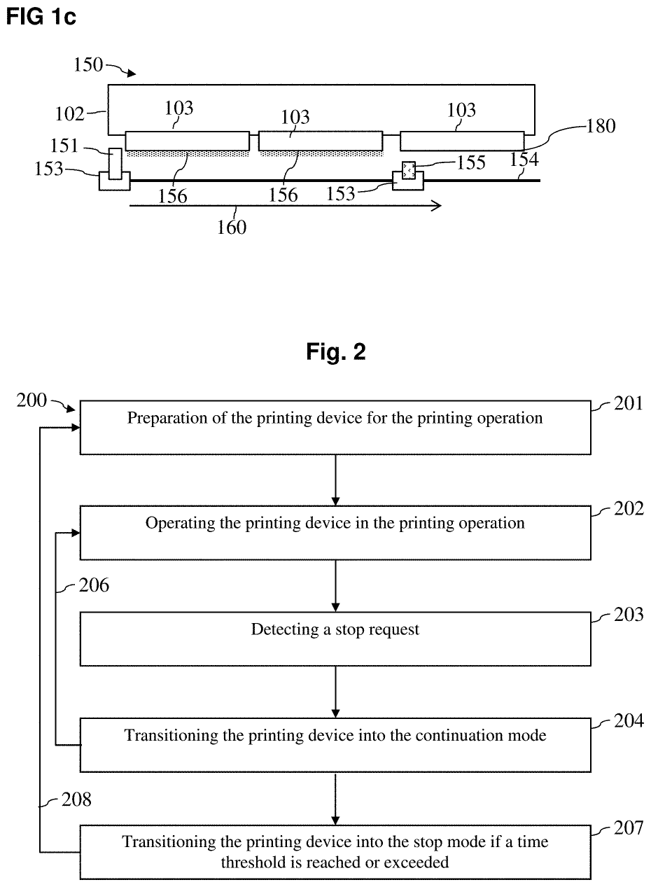

FIG. 2 shows a workflow diagram of an example of a method 200 for the interruption of the printing operation of an inkjet printing device. The printing device 100 comprises at least one print head 103 having at least one nozzle 21, 22. The printing device 100 typically comprises a plurality of print heads 103 that may be arranged in different print bars 102 for different ink types, in particular for different colors. A print head 103 also typically comprises a plurality of nozzles 21, 22.

The method 200 may include the preparation 201 of the printing device 100 for the printing operation before the beginning of said printing operation to print to a recording medium 120, in particular starting from a stop mode of the printing device 100. The at least one print head 103 may thereby be purged with ink. The nozzle plate 180 of the print head 103 may also be sprayed with cleaning fluid 156 and subsequently be wiped off. This may take place in the regenerator 150 of the printing device 100.

Furthermore, the method 200 may include the operation 202 of the printing device 100 for printing to a recording medium 120, in particular a recording medium 120 in the form of a belt or web, by means of the at least one print head 103. The printing device 100 may thus be transitioned into the printing operation. During the printing operation, the ink in the print head 103 and/or the dryer 190 of the printing device 100 may thereby respectively be set to a respective target temperature via active tempering, in particular via active heating. A uniformly high print quality may thus be achieved.

The method 200 may also include the detection 203 of a stop request to interrupt the printing operation. For example, it may be detected that the user of the printing device 100 has requested an interruption of the printing operation via a user interface of the printing device 100. The printing to the recording medium 120 may thereupon be interrupted.

The method 200 moreover includes transitioning 204 the printing device 100 from the printing operation into the continuation mode in reaction to the detected stop request to stop the printing operation of the printing device 100. In the continuation mode, the printing to the recording medium 120 may then be interrupted. In other words, it may be effected that the printing device 100 no longer prints to the recording medium 120 in the continuation mode. The advancement of the recording medium 120 may also be stopped so that the recording medium 120 stands still during the continuation mode.

Furthermore, an active tempering of the ink in the print head 103 takes place in the continuation mode. In particular, in the continuation mode a tempering may take place to the target temperature which also applies to the printing operation. In other words, it may be effected that the ink in the print head 103 exhibits the same temperature in the continuation mode as in the printing operation. In the continuation mode, the dryer 190 may also continue to be held, via active tempering, at the target temperature for the dryer 190 in the printing operation.

The method 200 may moreover include the resumption 206, 208 of the printing operation of the printing device 100 in reaction to a subsequent restart request to restart the printing operation of the printing device 100. The restart request may have been produced by the user via the user interface of the printing device 100.

The resumption 206 may, if applicable take place directly from the continuation mode. In this instance, no pre-tempering of the ink and/or of the dryer 190 is required. A purging with ink within the cleaner 150 of the printing device 100 in preparation for a restart of the printing operation may also typically be omitted. A relatively fast restart of the printing operation is thus enabled. In particular, the step 202 of the method 200 may take place directly without execution of step 201.

Furthermore, the method 200 may include the transitioning 207 of the printing device 100 into the stop mode if the duration of the interruption of the printing operation reaches or exceeds a defined time threshold, for example between 10 and 20 minutes. In stop mode, the active tempering of the ink in the print head 103 and/or the active tempering of the dryer 190 may be interrupted. As a result of this, during the stop mode the temperature of the ink and/or of the dryer 190 typically drops below the respective target temperature for the printing operation.

Upon resumption 208 of the printing operation from the stop mode, the preparation 201 of the printing device 100 for the printing operation typically initially takes place before the printing operation is resumed in a subsequent step 202. The resumption of the printing operation starting from a stop mode is thus typically linked with a longer time cost and with a greater resource cost than the resumption from the continuation mode.

Described in this document is a control device 101, in particular a controller 101 for a printing device 100, for interrupting the printing operation of an inkjet printing device 100. The printing device 100 may be designed as described in conjunction with FIG. 1a. In particular, the printing device 100 may have at least one print head 103 having at least one nozzle 21, 22 for printing to a recording medium 120.

The control device 101 is configured to transition the printing device 100 from the printing operation into the continuation mode in reaction to a detected stop request to stop the printing operation of the printing device 100. The operation of the printing device 100 in continuation mode may thereby be time-limited, for example to a maximum duration that corresponds to a time threshold.

As was already presented above, in the continuation mode the printing to the recording medium 120 by means of the at least one print head 103 is interrupted. The recording medium 120 is also halted. For this purpose, the transport velocity of the recording medium 120 may be reduced along a ramp, and the printing to the recording medium 120 may be slowed accordingly until ultimately the recording medium 120 is at a standstill and the printing to the recording medium 120 is interrupted. The continuation mode may begin as of the point in time at which the recording medium 120 is at a standstill and/or at which the printing to the recording medium 120 is ended.

Furthermore, an active tempering of the ink in the print head 103 takes place during the continuation mode of the printing device 100, in particular to a target temperature for the ink during the printing operation.

The printing device 100 may comprise a dryer 190 for drying a print image printed by the print head 103 on the recording medium 120. The control device 101 may be configured to also continue the active tempering of the dryer 190 to the target temperature for the printing operation while the printing device 100 is in the continuation mode.

By continuing the tempering of the ink and/or of the dryer 190, an accelerated restart of the printing operation of the printing device 100 from the continuation mode may be enabled.

The control device 101 is also configured to resume the printing operation of the printing device 100 in reaction to a subsequent restart request to restart the printing operation of the printing device 100. The resumption may thereby take place in an accelerated manner, without re-tempering the ink and/or the dryer 190 to the target temperature for the printing operation, if the resumption is made directly from the continuation mode. The time cost and the resource cost for an interruption of the printing operation of a printing device 100 may thus be reduced.

A control device 101 is thus described that is designed to transition an inkjet printing device 100, starting from the printing operation, at least temporarily into a continuation mode in which the printing is interrupted but in which the active tempering of the ink in the one or more print heads 103, and/or the active tempering of the dryer 190 of the printing device 100, is continued in order to enable an accelerated restart of the printing operation in a resource-efficient manner.

During the printing operation, the print head 103 is located in a printing position above the recording medium 120 to be printed to. In the continuation mode, the control device 101 may be configured to transition the print head 103 into a park position in which the nozzle plate 180 of the print head 103 is covered, and/or in which the print head 103 continues to be arranged above the recording medium 120 to be printed to. The drying out of the ink in the print head 103 may be reliably slowed by covering the nozzle plate 180. The arrangement of the print head 103 in a park position directly above the recording medium 120 also enables an accelerated restarting of the printing operation.

The control device 101 may be configured to have the effect that the nozzle plate 180 of the print head 103 is sprayed with a cleaning fluid 156 and subsequently wiped off in the transition from the printing operation into the continuation mode, in particular without ink thereby being flushed through the nozzle 21, 22 of the print head 103. Furthermore, the control device 101 may be configured to have the effect that the print head 102 is transitioned into a cleaning position for spraying of the cleaning fluid 156 and for subsequent wiping off of the nozzle plate 180 of the print head 103, in which cleaning position the print head 103 is arranged next to the recording medium 120 to be printed to. After the end of the cleaning of the nozzle plate 180 of the print head 103, said print head 103 may then be transitioned into the aforementioned park position in order to wait for the restart of the printing operation.

A cleaning of the nozzle plate 180 of the print head 103 may thus take place directly at the beginning of the continuation mode, i.e. directly following the interruption of the printing operation. A high print quality of the printing device 100 after resumption of the printing operation may thus be enabled in a time-efficient manner.

The control device 101 may be configured to determine that the duration since the stop of the printing operation and/or since the beginning of the continuation mode has reached or exceeded a predefined time threshold. The time threshold may, for example, be between 5 minutes and 30 minutes, for example at 10 minutes or at 20 minutes. In reaction to exceeding the maximum permissible duration for the continuation mode, the printing device may then be transitioned into the stop mode, wherein typically no active tempering of the ink in the print head 103 and/or no active tempering of the dryer 190 takes place in the stop mode.

It may this be detected that a relatively long interruption of the printing operation of the printing device 100 is present. The continuation mode is thereupon interrupted, and/or a transition into the stop mode thereupon takes place. In contrast to the continuation mode, the stop mode may be linked with a regeneration procedure upon resuming the printing operation in order to ensure a high print quality even after a relatively long printing pause. The print quality of the printing device 100 may thus be increased via the time limitation of the continuation mode.

The control device 101 may be configured to check, in reaction to the detected restart request to restart the printing operation of the printing device 100, whether the printing device 100 is in the continuation mode or in the stop mode. A purging of the nozzle 21, 22 of the print head 103 may then—possibly only then—be effected before the printing operation is restarted if it is determined, in reaction to the restart request, that the printing device 100 is in the stop mode. On the other hand, a restart of the printing operation without purging of the nozzle 21, 22 of the print head 103 with ink may be effected if it is determined, in reaction to the restart request, which the printing device 100 is in the continuation mode. A high print quality may thus be ensured, independently of the duration of the interruption of the printing operation.

The control device 101 may also be configured to have the effect, in preparation for a restart of the printing operation starting from the stop mode, that the ink in the print head 103 and/or the dryer 190 are brought and/or set to the respective target temperature for the printing operation via active tempering. Alternatively or additionally, the control device 101 may be configured to have the effect, in preparation for a restart of the printing operation starting from the stop mode, that the nozzle plate 180 of the print head 103 is sprayed with cleaning fluid 156 and is subsequently wiped off. Alternatively or additionally, the control device 101 may be configured to have the effect, in preparation for a restart of the printing operation starting from the stop mode, to transition the print head 103 out of the cleaning position—in which the print head 103 is arranged next to the recording medium 120 to be printed to—into the printing position for the printing operation. Given a restart starting from the stop mode, a regeneration of the print head 103 in the regenerator 150 of the printing device 100 may thus be implemented, in reaction to a restart request, in order to ensure a high print quality even after a relatively long printing pause.

Furthermore, the control device 101 may be configured to transition the print head 103, in preparation for the restart of the printing operation starting from the continuation mode, directly from the park position—in which the print head 103 is arranged above the recording medium 120 to be printed to—into the printing position for the printing operation. It may also be suppressed that the nozzle plate 180 of the print head 103 is sprayed with cleaning fluid 156 and is subsequently wiped off. In particular, given a restart produced by a restart request, starting from the continuation mode, a regeneration of the print head 103 in the regenerator 150 may be omitted. A rapid and resource-efficient restart may thus be enabled given a relatively brief printing pause.

The control device 101 may be configured to produce a negative pressure of the ink in the print head 103 during the continuation mode, said negative pressure being increased relative to that of the printing operation. In other words, it may be produced that the ink is drawn deeper into the one or more nozzles 21, 22 during the continuation mode, in particular deeper into the nozzle chambers of the one or more nozzles 21, 22 of the print head 103. The drying out of the ink during the printing pause may thus be more efficiently and reliably slowed.

The control device 101 may be configured to have the effect, within the scope of the printing operation of the printing device 100, that the print head is arranged in the printing position above the recording medium 120 to be printed to. For this purpose, the print head 103 may be transitioned into the printing position at the beginning of the printing operation and then be held in said printing position. Alternatively or additionally, the control device 101 may be configured to have the effect, within the scope of the printing operation of the printing device 100, that a print image is printed on the recording medium 120 by means of the print head 103. The print image may be printed depending on print data for the print image. Alternatively or additionally, the control device 101 may be configured to effect, within the scope of the printing operation of the printing device 100, an active tempering of the ink in the print head 103 and/or an active tempering of the dryer 190 in the print head 103 to a respective target temperature for the printing operation.

Furthermore, in this document a printing device 100 is described that comprises the control device 101 described in this document.

Via the measures described in this document, a resource-efficient, temporary interruption of the printing operation of a printing device 100 may be enabled.

To enable those skilled in the art to better understand the solution of the present disclosure, the technical solution in the embodiments of the present disclosure is described clearly and completely below in conjunction with the drawings in the embodiments of the present disclosure. Obviously, the embodiments described are only some, not all, of the embodiments of the present disclosure. All other embodiments obtained by those skilled in the art on the basis of the embodiments in the present disclosure without any creative effort should fall within the scope of protection of the present disclosure.

It should be noted that the terms “first”, “second”, etc. in the description, claims and abovementioned drawings of the present disclosure are used to distinguish between similar objects, but not necessarily used to describe a specific order or sequence. It should be understood that data used in this way can be interchanged as appropriate so that the embodiments of the present disclosure described here can be implemented in an order other than those shown or described here. In addition, the terms “comprise” and “have” and any variants thereof are intended to cover non-exclusive inclusion. For example, a process, method, system, product or equipment comprising a series of steps or modules or units is not necessarily limited to those steps or modules or units which are clearly listed, but may comprise other steps or modules or units which are not clearly listed or are intrinsic to such processes, methods, products or equipment.

References in the specification to “one embodiment,” “an embodiment,” “an exemplary embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The exemplary embodiments described herein are provided for illustrative purposes, and are not limiting. Other exemplary embodiments are possible, and modifications may be made to the exemplary embodiments. Therefore, the specification is not meant to limit the disclosure. Rather, the scope of the disclosure is defined only in accordance with the following claims and their equivalents.

Embodiments may be implemented in hardware (e.g., circuits), firmware, software, or any combination thereof. Embodiments may also be implemented as instructions stored on a machine-readable medium, which may be read and executed by one or more processors. A machine-readable medium may include any mechanism for storing or transmitting information in a form readable by a machine (e.g., a computer). For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.), and others. Further, firmware, software, routines, instructions may be described herein as performing certain actions. However, it should be appreciated that such descriptions are merely for convenience and that such actions in fact results from computing devices, processors, controllers, or other devices executing the firmware, software, routines, instructions, etc. Further, any of the implementation variations may be carried out by a general-purpose computer.

For the purposes of this discussion, the term “processing circuitry” shall be understood to be circuit(s) or processor(s), or a combination thereof. A circuit includes an analog circuit, a digital circuit, data processing circuit, other structural electronic hardware, or a combination thereof. A processor includes a microprocessor, a digital signal processor (DSP), central processor (CPU), application-specific instruction set processor (ASIP), graphics and/or image processor, multi-core processor, or other hardware processor. The processor may be “hard-coded” with instructions to perform corresponding function(s) according to aspects described herein. Alternatively, the processor may access an internal and/or external memory to retrieve instructions stored in the memory, which when executed by the processor, perform the corresponding function(s) associated with the processor, and/or one or more functions and/or operations related to the operation of a component having the processor included therein. In one or more of the exemplary embodiments described herein, the memory is any well-known volatile and/or non-volatile memory, including, for example, read-only memory (ROM), random access memory (RAM), flash memory, a magnetic storage media, an optical disc, erasable programmable read only memory (EPROM), and programmable read only memory (PROM). The memory can be non-removable, removable, or a combination of both.

### REFERENCE LIST

1 transport direction (of the recording medium)
2 movement direction (of a print bar)
21, 22 nozzle
31, 32 column (of the print image)
100 printing device
101 controller
102 print bar
103 print head
120 recording medium
140 print group
150 regenerator
151 wiper
152 cleaner
153 sled/wiper mount
154 guide rail
155 applicator (spray nozzle)
156 (cleaning) fluid
160 cleaning axis
180 nozzle plate
190 dryer
200 method for interrupting the printing operation of a printing device
201-208 method operations

1. A controller for interrupting a printing operation of an inkjet printing device having at least one print head having at least one nozzle, the controller comprising:
an interface; and
processing circuitry that is configured to:
transition, in response to a detected stop request, received via the interface, to stop the printing operation of the printing device, the printing device from the printing operation into a continuation mode, wherein the continuation mode includes interrupting printing to a recording medium by the at least one print head and continuing an active tempering of ink in the at least one print head; and
resume the printing operation of the printing device in response to a subsequent restart request, received via the interface, to restart the printing operation of the printing device.

2. The controller according to claim 1, wherein:
during the printing operation, the at least one print head is arranged in a printing position above the recording medium; and
in the continuation mode, the processing circuitry is configured to transition the at least one print head into a park position in which a nozzle plate of the at least one print head is covered and in which the at least one print head continues to be arranged above the recording medium.

3. The controller according to claim 1, wherein the processing circuitry is configured to cause a nozzle plate of the at least one print head to be sprayed with a cleaning fluid and subsequently be wiped off upon a transition from the printing operation into the continuation mode.

4. The controller according to claim 3, wherein the transition from the printing operation into the continuation mode is performed without ink being flushed through the at least one nozzle of the at least one print head.

5. The controller according to claim 3, wherein the processing circuitry is configured to cause the at least one print head to transition into a cleaning position for the spraying of the cleaning fluid and for the subsequent wiping off of the at least one nozzle plate of the print head, the cleaning position includes the at least one print head being arranged next to the recording medium.

6. The controller according to claim 1, wherein the processing circuitry is configured to:
determine whether a duration since a stop of the printing operation and/or since a beginning of the continuation mode has reached or exceeded a predefined time threshold; and
in response thereto, transition the printing device into a stop mode in which no active tempering of the ink in the at least one print head is performed.

7. The controller according to claim 1, wherein the processing circuitry is configured to:
check, in in response to the detected restart request to restart the printing operation of the printing device, whether the printing device is in the continuation mode or in a stop mode;
cause a purging of the at least one nozzle of the at least one print head with ink to be restarted before the printing operation in response to the printing device being in the stop mode; and
cause the restart of the printing operation without purging the at least one nozzle of the at least one print head with ink in response to the printing device being in the continuation mode.

8. The controller according to claim 7, wherein the processing circuitry is configured to:
in preparation for restarting the printing operation starting from the stop mode:
cause the ink in the at least one print head to be set, via active tempering, to a target temperature for the printing operation;
cause a nozzle plate of the at least one print head to be sprayed with cleaning fluid and subsequently to be wiped off; and
transition the at least one print head from a cleaning position, in which the at least one print head is arranged next to the recording medium to be printed to, into a printing position for the printing operation; and/or
in preparation for restarting the printing operation starting from the continuation mode:
transition the print head from a park position, in which the at least one print head is arranged above the recording medium to be printed to, into the printing position for the printing operation; and
suppress the nozzle plate of the at least one print head from being sprayed with the cleaning fluid and subsequently being wiped off.

9. The controller according to claim 7, wherein the processing circuitry is configured to:
in preparation for restarting the printing operation starting from the stop mode:
cause the ink in the at least one print head to be set, via active tempering, to a target temperature for the printing operation;
cause a nozzle plate of the at least one print head to be sprayed with cleaning fluid and subsequently to be wiped off; and
transition the at least one print head from a cleaning position, in which the at least one print head is arranged next to the recording medium to be printed to, into a printing position for the printing operation; and
in preparation for restarting the printing operation starting from the continuation mode:
transition the print head from a park position, in which the at least one print head is arranged above the recording medium to be printed to, into the printing position for the printing operation; and
suppress the nozzle plate of the at least one print head from being sprayed with the cleaning fluid and subsequently being wiped off.

10. The controller according to claim 1, wherein the processing circuitry is configured to produce, during the continuation mode, a negative pressure of the ink in the at least one print head, the negative pressure being greater than a negative pressure in the printing operation.

11. The controller according to claim 1, wherein:
the printing device comprises a dryer configured to dry a print image printed by the at least one print head onto a recording medium; and
the processing circuitry is configured to cause an active tempering of the dryer to a target temperature while the printing device is in the continuation mode.

12. A method for interrupting a printing operation of an inkjet printing device having at least one print head having at least one nozzle, the method comprising:
transitioning the printing device from the printing operation into a continuation mode in response to a detected stop request to stop the printing operation of the printing device, wherein, in the continuation mode, the printing of a recording medium by the at least one print head is interrupted and an active tempering of ink in the at least one print head continues to be performed; and
resuming the printing operation of the printing device in response to a subsequent restart request to restart the printing operation of the printing device.

13. A non-transitory computer-readable storage medium with an executable program stored thereon, that when executed, instructs a processor to perform the method of claim 12.

14. A controller comprising processing circuitry that is configured to perform the method of claim 12.
